(19) United States
(12) Patent Application Publication
(10) Pub. No.: US 2016/0260306 A1
(43) Pub. Date: Sep. 8, 2016

(54) METHOD AND DEVICE FOR AUTOMATED EARLY DETECTION OF FOREST FIRES BY MEANS OF OPTICAL DETECTION OF SMOKE CLOUDS

(71) Applicants: Klaus JÄCKEL, Schönefeld (DE); Andreas JOCK, Rangsdorf (DE); Uwe KRANE, Berlin (DE); Azarm NOWZAD, Berlin (DE); Holger VOGEL, Berlin (DE); IQ WIRELESS GMBH ENTWICKLUNGSGESELLSCHAFT FÜR SYSTEME UND TECHNOLOGIEN DER TELEKOMMUNIKATION, Berlin (DE); DEUTSCHES ZENTRUN FÜR LUFT-UND RAUMFAHRT, Koeln (DE)

(72) Inventors: Klaus JÄCKEL, Schönefeld (DE); Andreas JOCK, Rangsdorf (DE); Uwe KRANE, Berlin (DE); Azarm NOWZAD, Berlin (DE); Holger VOGEL, Berlin (DE)

(73) Assignees: IQ Wireless GmbH Entwicklungsgesellschaft für Systeme und Technologien der Telekommunikation, Berlin (DE); Deutsches Zentrum für Luft-und Raumfahrt, Köln (DE)

(21) Appl. No.: 15/030,469

(22) PCT Filed: Oct. 18, 2014
(86) PCT No.: PCT/DE2014/000520

§ 371 Date: Apr. 19, 2016

(30) Foreign Application Priority Data
Oct. 19, 2013 (DE) 10 2013 017 395.7

(51) Int. Cl. G08B 17/12; G06K 9/32; G08B 29/18; G06N 7/02; G08B 17/00; G06K 9/00; G06K 9/62

(52) U.S. Cl. CPC G08B 17/125; G06K 9/00657; G06K 9/3233; G06K 9/6277; G06N 7/02; G08B 17/005; G08B 29/186

(57) ABSTRACT

A method for the automated early detection of forest fires by means of the optical detection of clouds of smoke, includes the following steps: producing images by means of at least one digital color-image camera and transmitting said images to a digital data processing medium; defining membership functions in a fuzzy-logic system for the classes “smoke,” “forest,” and “dark surface” by evaluating a plurality of test images or test sequences recorded by the color-image camera with respect to the saturation value (S) of the image pixel.

The invention relates to a method for automated early detection of forest fires by means of optical detection of smoke clouds.

Forest fires pose a particular risk regarding economical and ecological effects and damage. Even though such fires cannot be completely prevented their early detection plays a very important role in damage control. While in past decades this task was in particular performed by human observers, there are increasing efforts to use appropriate technical solutions to remedy the shortcomings and costs of human observers.

In spite of intensive global research efforts that focus on the mentioned issue, commercially available technical systems are currently only sparsely used. Among many tested and generally different methods currently mainly optical methods with smoke recognition are used which are implemented in terrestrial systems and are operated from exposed locations in forested areas (towers or the like).

Compared to other technical approaches, such as satellite-supported methods and methods that are based on the detection on other physical parameters of the fire (for example heat or infrared radiation), these systems nevertheless play an important role.

Compared to the other solutions the described system solution with optical and computer-supported image processing for automated smoke detection is characterized predominantly in that emerging fires can be detected very early, in which the heat development is still minor and a cost-effective detection can be achieved because a detection unit positioned at a certain location can monitor a forest surface of multiple 100 km² while still realizing detection times of a few minutes. As a result such systems already today are on par with the capabilities of traditional human observers.

However for a comprehensive practical application the available optical systems with automated methods for smoke detection have a significant disadvantage found in their high error rate, i.e., the positive detection of smoke in spite of the absence of an actual forest fire, for example due to cloud shadows, dust swirls and the like. This disadvantage has to be compensated by a human operator (supervisor) who verifies a corresponding autonomously detected forest fire situation based on image data and experience and has to make a final decision regarding further steps to be taken (alerting fire department or ignoring the alert).

In praxis this relatively high error rate leads to a high psychological stress on the operating personnel, because the number of false alarms is usually significantly higher than the number of reports of actual fires, and further leads to relatively high personal costs because an operator can only evaluate and control a small number of autonomously operating optical system in parallel, and results in an acceptance problem for using the automated systems because in spite of objectively equal or better detection results than from human observation their subjective perception and evaluation is different.

The currently known approaches for reducing false alarms are predominantly based on the fact that multiple independent features of smoke are extracted and analyzed by corresponding image processing routines. The decision confidence is improved by appropriate combination of these results.

Known are inter alia the following features and properties of smoke, which are analyzed by intelligent image processing. For example differences in brightness relative to the environment, partially with adaptive thresholds, are described in U.S. Pat. No. 7,542,585 B2. Further, the measurement of similar contours is described in DE 10 2009 048 739 B3 which relate to a method and a device for automatic detection of forest fires. Further temporal and spatial preferential directions (“smoke rises upwards” or “smoke expands in all directions—in contrast to moving clouds”) are described in EP 1 994 502 B1 for a method and device for smoke detection.

Such spatial and temporal cluster analyses are described in EP 1 628 260 B1. Further the determination and analysis of low frequency brightness fluctuations by Fourier transformations and frequency analyses are disclosed in U.S. Pat. No. 6,937,743 B2.

For the analysis and combination of the individual features and parameters of the smoke to be detected in the images majority decision, valuation tables and also more recent methods such as artificial neuronal networks and Fuzzy Logic are proposed and used.

The optical sensors are usually configured as black-white detectors, which do not detect color information. Black-white sensors are more sensitive and provide higher contour contrast than comparable color sensors; in addition the images require less process effort. Over large distances of more than about 5 kilometers color information is mostly lost due to atmospheric effects, so that in the case of larger areas sought to be monitored by a sensor the color information can only be analyzed in subregions.

The use of color sensors and the automated processing and analysis of color information for the purpose of smoke detection are generally known. The sensors herby record intensity values in three independent color channels for example red, green, blue (RGB) for each pixel and process the corresponding data. This three-dimensional color space can also be converted by corresponding functional transformations. A frequently used color space is herby the so-called HSV space, which combines the color value H as angle between 0=red, 120=green, 240=blue, the saturation S between 0 and 100 and the brightness value V between 0 and 100, and can be obtained via a corresponding transformation from the RGB space. The corresponding formulas are generally known.

The color images are frequently analyzed regarding the presence of open fires or flames as well as smoke. The analysis of color images with regard to the detection of smoke hereby focuses on the following features and parameters:

The contrast in the images is measured and when falling below a threshold is interpreted as the presence of smoke, as for example disclosed in U.S. Pat. No. 4,614,968. This contrast analysis however does not necessarily require a color image; a (relatively coarse) pre-classification as smoke is performed, when the pixels of defined image regions are present in each color channel or the color saturation is within predefined thresholds. This pre-classification is based on the fact that smoke only has weakly pronounced individual color components. However, this pre-classification is very unreliable so that the actual decision then has to rely on evaluating further structure analyses as described above.

An application of Fuzzy Logic when summarizing the results of separate methods for the flame and smoke recognition in color images is also described in U.S. Pat. No. 7,543,585. However, the application is limited to the combination and weighted analyses of the results of separate closed algorithms for fire detection.

All methods mentioned above only analyze one color information, i.e., the color value (H) or the amount of white of certain image regions (brightness value (V)). In this case only the property of the smoke to dampen color proportions of the background or to possess a high white component itself is used.

It is an object of the present invention to provide an automated method for early forest fire detection within a close monitored area by means of optical detection of smoke clouds.

This object is solved by the features set forth in patent claim 1, in particular by the recording of images by means of a color camera and transmission of the images to a digital data processing medium and defining of assignment functions in a Fuzzy Logic system into field categories such as the classes “smoke” “forest” and “dark surface” by analyzing a plurality of test images or test sequences recorded by the color camera with regard to the saturation value of the image pixels.

According to a preferred embodiment assignment functions are then defined in a Fuzzy Logic-system into field categories such as “smoke” “forest” and “sky” by analyzing a plurality of test images or test sequences with regard to the brightness value of the image pixel and then a threshold value is defined for the classification as “smoke” by analyzing a plurality of test images or test sequences with regard to the color value of the image pixel.

Further a Fuzzy-Logic rule set is defined for the S-channel (saturation) and V-channel (brightness) based on the preformed analyses, which define the qualitative rules what parameter combination is evaluated as “smoke” and what is not.

The following procedures are performed which are applied to the entire image content or to a limited region the so-called Region-Of-Interest (ROI), when due to information obtained otherwise smoke can only occur in these regions, i.e.:
determining a Fuzzy function and assignment function with concrete number values for the categorization into the corresponding parameter combination for each of the two channels S and V by way of a plurality of images and scenarios;
determining the threshold value of this Fuzzy function for the categorization of an image pixel as “smoke” and determining the threshold value for the number of categorized image pixel of an ROI by way of a plurality of images and scenarios in order to generate a fire alarm.
performing the following method steps for each recorded image:
dividing the color images recorded with the digital color camera into regions that are relevant for the further analysis (ROI);
pre-classification of these potentially relevant regions (ROI) in which smoke may be present;
for this transmitting all individual pixel in the ROI into the HSV space and analyzing all pixel in this HSV space;
analyzing the pixel first for the H-channel (color value), comparing with the threshold value for the classification as “smoke” and performing the following method steps when the threshold value is exceeded and in case of the classification “no smoke” and analyzing the next image pixel in the ROI when the threshold value is not exceeded;
determining the assignment value for the S-channel (saturation) and V-channel (brightness value) with regard to the defined classes;
determining the Fuzzy-Function for the image pixel, comparing with the threshold value for the classification as “smoke” when the threshold value is exceeded and classification as “no smoke” when the threshold value is not exceeded, and transitioning to the analysis of the next image pixel within the ROI;
summing up the number of all image pixels that were classified as “smoke” over the entire relevant surface (ROI);
when at least one predefined number of the analyzed pixel of the corresponding region was determined as “smoke”, “smoke” is reported and the image region of the corresponding region in which it occurs is marked;
Triggering a fire alarm.

According to the invention further criteria and parameters are deduced from the color images, because 3 color channels are detected. Herby intensive tests have shown that depending on the background of the smoke different threshold values and rules would have to be applied. These connections are not accurately determined but are better described by heuristic rules.

In the following the discovered connections are described and the device and the method for smoke detection introduced.

A representation in the HSV color space (H=color value, S=color saturation, V=brightness value) has been shown to be advantageous. The abbreviation HSV is derived form the English terms for H=Hue, S=Saturation and V=value.

Via links between the brightness value and saturation value and taking an a priori known background (for example dark forest surface or bright sky) into account probability statements regarding a possible classification of the pixel as smoke can then be made via appropriate coefficients and their parameterization. Also the color value is hereby taken into account as exclusion criterion because a corresponding smoke pixel has to originate form a limited H-region (H=color value).

Due to the complexity of the relationships a representation of this relationship cannot be defined via simple functional relationships. However by means of a Fuzzy-Logic blurry and not strictly described relationships can be represented well and also parameterized relatively easily.

The relationships that were found by extensive tests based on a plurality of different image scenarios are illustrated in the following sequences and charts.

In this preferred embodiment of the present invention the environmental conditions of the operation are permanently determined and the threshold values and assignment functions adjusted in dependence thereon.

According to a further embodiment of the present invention the threshold values and assignment functions are adaptively adjusted by system wide feedback and recalculation by continuous analysis of the results of the automatic method for detection with actual fires and/or to detected fires.

Further methods for geo-referencing are used for pre-classification of the potentially relevant region (ROI) in which smoke may be present, wherein the spatial position and orientation of the camera can be determined by means of corresponding sensors and an adjustment of the image regions is performed with corresponding topographical data and terrain models so that the ROIs are limited to regions that were defined beforehand or corresponding regions are excluded, and can be used for definition of field categories.

According to a further embodiment of the present invention the method and tits algorithms are implemented via at least one digital data processing medium which is capable of processing image data.

In a preferred embodiment of the present invention the analyzed digital images can be displayed on at least one monitor connected with the digital data processing medium, wherein corresponding detected smoke regions are marked with appropriate means and can be displayed on the monitor.

Hereby the appropriate means can include a frame, a color background or a stylistic marking of the detected smoke regions.

According to a further embodiment of the present invention the digital data processing medium and the monitor can be coupled to each other via at least one wireless connection, wherein the screen can be assigned to a mobile phone or a tablet-PC which are configured for the reception and the processing of the data sets generated by the digital data processing medium. This enables the data sets to be digitally accessed. A spatial stationing of a user for example in an analysis and evaluation center connected to a processing center is thus not required.

A further object of the present invention is to provide a device for implementing the method according to claims 1 to 11 for automated early detection of forest fires by means of optical detection of smoke clouds, with at least one digital data processing medium for processing and analyzing digital image information in the optical close range.

This object is solved according to claim 12, in particular with a device including at least one medium for digital image processing of digital image information with a digital color camera, wherein the digital data processing medium is operatively connected with a digital color camera, which transmits color image recordings within the detection range of the color differences of the color image sensors installed in the digital camera, from the installation place of the digital camera to the data processing medium for further processing.

According to an embodiment of the device according to the invention, the color camera is assigned at least one light-sensitive sensor, wherein the pixels of the sensor have different spectral sensitivities in order to obtain brightness or color information from pixels of the same or neighboring positions.

In a further preferred embodiment of the device according to the invention, a region for storing test images for parameterization of the topographies and terrain properties is assigned to the digital data processing medium, which the system automatically accesses for system calibration. This makes it possible for the system to autonomously teach itself from the stored comparison images and a adjustment with the actually encountered topographies.

According to a further embodiment of the present invention, it is provided to constantly determine the environmental conditions during operation of the system and depending thereon to adjust the threshold values and the assignment functions adaptively, wherein for this purpose the system can access the region for storing test images and/or the parameterization of the topographies and the individual terrain properties of the site of installation of the device.

A digital data processing medium mobile and stationary computers as well as mobile phones that are capable for data processing are conceivable. It is also possible to directly upload the monitoring data determined by the device via mobile radio network to a mobile phone, a tablet-PC, a foldable calculator or other appropriate digital data processing medium via digital (for example by means of UMTS or LTE) network standards or analog radio transmission means.

It is also provided to transmit a fire report directly to the command center of the corresponding forces in charge. A user can thus be informed directly and in real-time regarding a corresponding fire report.

When no fire report is issued, the above-described media enable access to the device for example to view real-time images of the area to be monitored.

In the following the invention is explained in more detail by way of exemplary embodiments with reference to the included drawings; it is shown in:

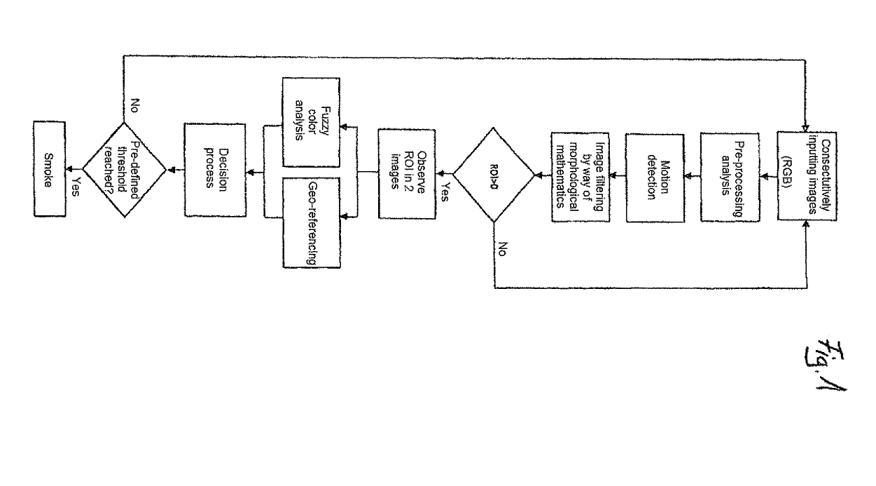

FIG. 1 a flowchart of the performed method steps for automated early detection of forest fires by means of optical detection of smoke clouds;

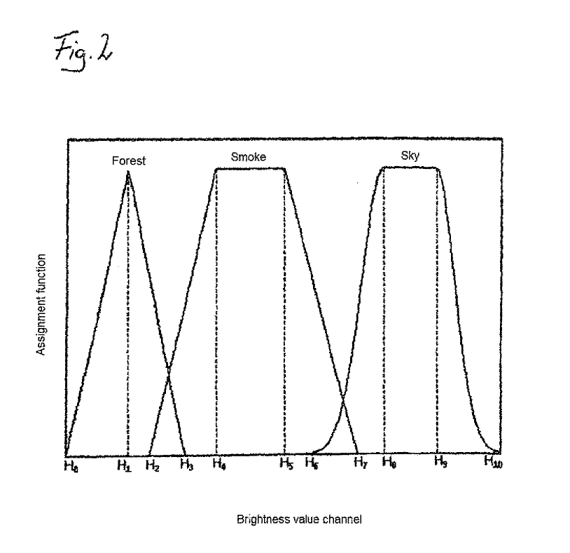

FIG. 2 a schematic representation of the analyzed brightness value with defined assignment functions to the field categories “forest”, “smoke” and “sky”;

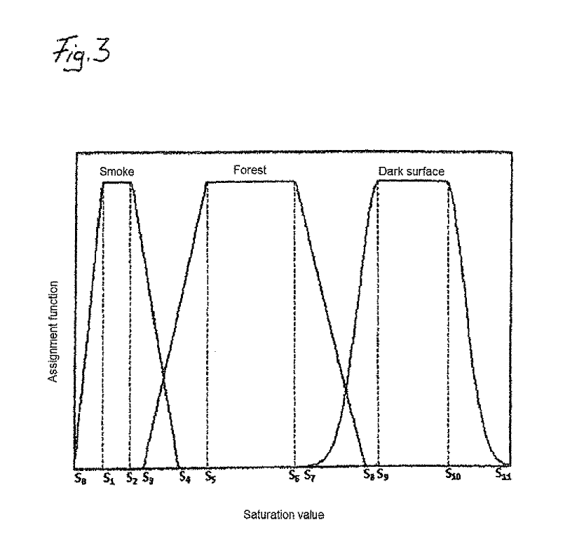

FIG. 3 a schematic representation of the analyzed saturation channel with defined assignment functions “smoke”, “forest” and “dark surfaces”.

FIG. 1 is a flowchart of the work steps of the method according to the invention. In a first step the consecutive images are inputted. For illustration the basic colors red, green blue are used (RGB).

Thereafter a pre processing analysis is performed followed by motion detection. Further image filtering is performed by way of morphological mathematics.

The color images recorded with the digital camera and to be analyzed are first divided into regions that are relevant for the further analysis—the so-called ROPI (region of interest)—and are pre classified as regions in which smoke may potentially be present.

In addition topographical maps and data as well as topographical models can be used in connection with the concrete location of the camera and its spatial orientation, in order to further limit the interesting region and thus reduce the processing effort and possible false detections. For example defined image regions may be excluded in which no actual or potential smoke does not occur and/or are not relevant, such as for example in connection with traffic areas, lakes, settlements or industrial regions.

For this purpose the geographical position of the camera its installation height in connection with the optical characteristic values of the camera (for example focal distance, sensor size etc.) and its actual orientation during the image recording have to be known. This position determination of the camera can be determined and kept up to date via appropriate sensors (for example GPS, compass and positional sensors) also during the ongoing operation. The assignment and projection of cartographical regions to the recorded image regions (Geo-referencing) is then possible via known mathematical transformations.

When no ROIs result the next consecutive image is uploaded and the search or analysis regarding ROIs starts over.

When ROIs are recognized the following steps are performed: within these ROIs all pixels are analyzed and subjected to the calculation below according to the described algorithm. Within these ROIs all pixels are analyzed and subjected to the calculation below according to the described algorithm

First when the pixel data are initially present in the RGB space each individual pixel of these ROIs is first transformed into the HSV space (with H=color value, S=saturation, V=brightness value) by means of the known transformation method.

An analysis is first performed in the H-channel (color value). When the corresponding pixel is outside the defined threshold values, which are a priori known and set, the pixel is classified as “no smoke” and the next pixel of the image is processed. When the H-value is within the threshold values a further analysis is performed in the channels S (saturation) and V (brightness).

The threshold value is first determined on the basis of performed pre-tests with manual classification. Then these threshold values are verified for the actual location and modified if applicable by performing an adjustment by way of a number of test fires.

The new threshold value S_{—NEW} can hereby be determined from the old threshold value S_{—OLD} and the threshold value S_{—TEST} found during the tests, by using an empirical factor k from [0,1] with k being a real number and k<<1 for example as below:

S_{—NEW}=(1−k)*S_{—OLD}+k*S_{—TEST} [1]

A further possibility for adjusting the threshold value is that in pre-tests respective individual threshold values are determined in dependence on concrete environmental conditions such as light conditions (sunny, cloudy etc.) time of day/position of the sun, time of year, wind conditions. Depending on the concrete situation at the installed system, corresponding environmental parameters can then be detected by means of appropriate sensors (clock, light detector, wind sensor etc.) and the pre-determined individual threshold values set.

For the two other channels corresponding class assignments are performed due to the performed tests. For this for each saturation value the classes “smoke”, “forest” and “dark surface” are defined and for each brightness value the classes “forest” “smoke” and “sky”.

Afterwards concrete number values are defined as degree of membership of a defined class, i.e., the thus mentioned assignment functions are defined for the categorization into the corresponding class. The assignment functions μ_{A}: X→[0,1] assign each element of the definition set X={x}, i.e., the saturation value or the brightness value, a number from the real number interval [0,1] of the et which defines the degree of membership μ_{A}(x) of each element x to the thus defined fuzzy set or class A (“smoke”, “forest” etc.). The concrete number values for the assignment functions are determined experimentally by analyzing a plurality of images and scenarios.

This analysis occurs by counting methods, histogram analyses and/or formation of corresponding polynomials for approximation of the assignment functions to a defined class via a defined interval of the definition range.

The thus determined values serve as configuration data for a new detection system to be installed. The assignment functions are respectively specific for corresponding use scenarios for the early detection system (for example pine forests in northern Germany). This is illustrated by way of the following example, wherein the concrete number values were determined by test images as described.

FIG. 3 shows the graphical representation of the S-channel analysis. On the abscissa the saturation values are located from for example S₀ to S₁₁ and on the ordinate the degree of membership (for example for forest, smoke, sky) is shown.

First the function values for the S-channel (saturation) are formed as follows, the corresponding values and courses of the assignment functions are exemplary shown in the diagram. When the saturation is within the range between S₁ and S₂ a very sure assignment as “smoke” is performed. Transition regions in which “smoke is still possible, are located between S₀ and S₄.

When the saturation is in the range between S₅ and S₆ a very confident classification as “forest” is performed. Also in this case there are corresponding transition regions between S₃ and S₈ in which a classification can be performed with decreasing confidence. When the saturation is within the range S₉ and S₁₀ a very confident classification as “dark surface” is preformed. Transition regions in which “dark surface” is still possible are between S₇ and S₁₁.

Adequately corresponding assignment function values are also formed for the V-channel as follows, wherein the exemplary function values are shown in the diagram. A graphical representation of the V-channel analysis is shown in FIG. 2. Hereby the brightness values are blotted on the abscissa for example from H₀ to H₁₀ and on the ordinate the degree of membership—for example for forest, smoke or sky.

The confident classification to the class “forest” is hereby possible at a brightness value of H₁. When the brightness value is between H₀ and H₃ the assignment as “forest” can be performed with lower sureness as schematically shown in FIG. 2.

When the brightness value is within the range between H₇ and H₈ an assignment as “smoke” can be performed wherein the greatest sureness is between H₅ and H₅. When the brightness value is in the range between H₂ and H₇ an assignment as “smoke” can be performed, wherein the greatest sureness is between H₄ and H₅. When the brightness value is between H₈ and H₁₀ an assignment as sky” can be performed. A detected brightness value between H₈ and H₉ makes a confident classification to this class possible.

A further embodiment and specification of this assignment function can occur so that in a new installation of the detector system first a number of test images is generated and automatically analyzed. The concrete assignment functions can be adjusted based on these test results. The system is hereby configured so that it autonomously adjusts to the installation location.

The new degree of membership μ_{A}_{_}_{NEW}(x) can then be determined from the old degree of membership μ_{A}_{_}_{OLD}(x) and the degree of membership μ_{A}_{_}_{TEST}(x) determined from the test for example as follows:

μ_{A}_{_}_{NEW}(x)=(1−k)*μ_{A}_{_}_{OLD}(x)*μ_{A}_{_}_{TEST}(x) [2]

wherein k is an appropriately selected real number coefficient from the interval [0,1] with k<<1, which is to be regarded as a measure for the rate of change with regard to the sought adjustment.

A further possibility for adjusting the assignment function is that in pre-tests respective individual functional curves are determined in dependence on concrete environmental conditions such as for example lighting conditions (sunny, cloudy or the like) time of day, position of the sun, time of year, wind conditions. Depending on the concrete situation at the installed system then corresponding environmental parameters can be detected by means of appropriate sensors (clock, light sensor, wind sensor etc.) and the prior determined individual assignment functions set.

The individual assignment functions of saturation (S-channel) and brightness value (V-channel) are thus combined to the so-called fuzzy function. The corresponding rule set is defined via a matrix, which contains the combination of different classes and their concrete membership values values, which are then connected via qualitative rules (Fuzzy-rules). These qualitative rules contain in compressed form the accumulated expert knowledge regarding actually occurred fires from a multitude of analyzed images, which are analyzed with regard to the mentioned classes. Alternatively this expert knowledge can also occur via “if” □ “then” rules.

A quantification hereby occurs via the variable of the assignment function as shown in the image. The individual weighting factors form the assignment function and corresponding assignment are hereby for a defined class or classes combination to determine. For each of the described 3×3=9 combinations corresponding values, so-called Fuzzy values, result by this fuzzyfication.

With this a real number starting value of the Fuzzy function can be outputted for different environmental conditions form the interval [0,1] depending on the magnitude of the measured saturation values and brightness values. This number value represents a measure of the fuzziness of the decision to be made (smoke yes/no). Based thereupon the defuzzyfication is performed by the following hard decision: When the starting value is greater than a defined predefined threshold value, the pixel is interpreted as “smoke” otherwise as “no smoke”.

Finally all pixels that are interpreted as “smoke”, within the entire interesting surface ROI are added up. When at least one predefined total number of these pixel of the corresponding region were determined as “smoke”, “smoke” is reported and the corresponding region is marked as the image region in which the smoke occurs. Advantageously for an operator is the representation of the images to be analyzed and the marking of correspondingly detected smoke regions is performed with appropriate means (for example framing) in order to facilitate a visual verification.

Subsequently an adaptivity of the described methods and threshold value comparisons can be performed by introducing a feedback into the system. For this the starting values of the method solution are compared with the actual results with regard to a fire. After the procedures as described in formulas [1] and [2] a continuous adaption and correction of the threshold values and assignment functions can degree of membership can be performed.

1.-15. (canceled)

16. A method for automated early detection of forest fires by means of optical detection of smoke clouds, said method comprising:
recording images with a digital color camera and transmitting the images to a digital data processing medium;
defining assignment functions in a Fuzzy Logic system for the classes “smoke”, “forest” and dark surface” by analyzing a plurality of test images or test sequences recorded by the color camera with regard to a saturation value and a brightness value of image pixels of the images.

17. The method of claim 16, further comprising:
defining a threshold value for the classification as “smoke” by analyzing a plurality of test images or test sequences with regard to the color value of the image pixel; and
defining a Fuzzy-rule set for the S-channel (saturation) and V-channel (brightness value) based on the plurality of the recorded test images or test sequences of performed tests, which define the qualitative rules which parameter combination is evaluated as “smoke”.

18. The method of claim 17, further comprising:
determining assignment functions with concrete numbers for the categorization into the corresponding parameter combinations for each of the two channels saturation and brightness value by way of a plurality of images and scenarios and combining the individual assignment functions for the saturation (S-channel) and the brightness value (V-channel) to a Fuzzy Function; and
determining the threshold value of this Fuzzy function for the classification of an image pixel as “smoke” and determining the threshold value for the number of thusly classified image pixel of an ROI (Region of interest) by way of a plurality of images and scenarios in order to generate a fire alarm.

19. The method of claim 18, further comprising performing the following analysis of each recorded image:
dividing the color images recorded with a digital camera and to be analyzed into regions of interest which are interesting for the further analysis
pre-classifying the (ROI) in which smoke may be present,
for this purpose transforming all individual pixels in the ROI into the HSV space (H=color value, S=saturation, V=brightness value) and analyzing all pixels in this HSV space
analysis of the pixels first for the H-channel (color value), comparing with the threshold value for the classification as “smoke” and performing the following method steps when the threshold value is exceeded and classification as “no smoke” and analysis of the next image pixel within the ROI when the threshold value is not exceeded,
determining the assignment function values for the S-channel (saturation) and V-channel (brightness value/color intensity) with regard to the defined classes,
determining the Fuzzy function for the image pixel, comparing with the threshold value for the classification as “smoke” when the threshold value is exceeded and classification as “no smoke” when the threshold value is not exceeded and transitioning to the analysis of the next image pixel within the ROI,
summing up the number of image pixels of the surface (ROI) that is classified as smoke;
marking the image regions of the surface (ROI) that is classified as smoke; and
triggering a fire alarm.

20. The method of claim 16, wherein the environmental condition of the operation is constantly determined and the threshold values and assignment functions are adaptively adjusted and set in dependence of the environmental conditions.

21. The method of claim 20, further comprising adaptively adjusting the threshold values and assignment functions by a system wide feedback and recalculation based on results of a continuous analysis of results of the automated method for detection with actual fires and/or not detected fires the threshold values and assignment functions are adaptively adjusted.

22. The method of claim 21, wherein the pre-classification of the regions of interest in which smoke may be present, comprises gee-referencing and wherein the a position and orientation of the camera is determined by corresponding sensors and an adjustment of the image regions with corresponding topographical data and topography models is performed so that the regions of interest are limited to pre determined regions or corresponding regions are excluded, and are used for defining field categories.

23. The method of claim of 16, wherein the method and its algorithms implemented via at least one digital data processing medium.

24. The method of claim 23, wherein the images to be analyzed are displayed on a monitor which is connected with the digital data processing medium and the marking of corresponding detected smoke regions is performed with marking means.

25. The method of claim 24, characterized in that the marking means include a framing, a colored background or a stylistic marking of the detected regions.

26. The method of claim 16, wherein the digital data processing medium and the monitor can be coupled by means of at least one wireless connection, wherein the monitor is assigned to a mobile radio telephone or a tablet PC which are configured for reception and processing of the data generated by the digital data processing medium.

27. A device for automated forest fire early detection by means of optical detection of smoke clouds for performing the method of claim 16, comprising at least one digital data processing medium for processing digital image information and at least one digital camera, wherein the digital camera is a digital color camera and the digital data processing medium is operatively connected with the digital camera and its color sensors detect the color differences in their detection range and transmit the color image recordings form the site of installation of the digital camera to the data processing medium for further processing.

28. The device of claim 27, characterized in that at least one light-sensitive sensor is assigned to the camera, wherein the pixels of the sensor have different spectral sensitivities in order to receive of the same or neighboring positions brightness and color information or color intensity information.

29. The device of claim 27, characterized in that a region for storing test images is assigned to the digital data processing medium for parameterizing the topographies and topographic properties, which the system can automatically access for system calibration.

30. The device according to claim 29, characterized in that the environmental conditions are permanently determined during the operation of the system an in dependence thereon the threshold values and assignment functions are adaptively adjusted and set, wherein for this purpose the system accesses the region for storing test images and/or the parameterization of the topographies and topographical properties of the site of installation.
